(19) United States
(12) Patent Application Publication
(10) Pub. No.: US 2009/0240023 A1
(43) Pub. Date: Sep. 24, 2009

(54) ANION POLYMERS

(76) Inventors: Ramon Valls, Barcelona (ES); Jaime Tuduri, Terrassa (Barcelona) (ES)

Correspondence Address: FOX ROTHSCHILD LLP, 2000 MARKET STREET, PHILADELPHIA, PA, 19103, US

(21) Appl. No.: 11/577,888

(22) PCT Filed: Nov. 3, 2005
(86) PCT No.: PCT/EP05/11745

§ 371 Date: Apr. 25, 2007

(30) Foreign Application Priority Data
Nov. 12, 2004 (EP) 04026982.1

(51) Int. Cl. C08G 63/52

(52) U.S. Cl. 528/303

(57) ABSTRACT

A process for preparing anionic polymers, including the steps of: (a) polymerizing one or more olefinically unsaturated carboxylic acids or esters thereof with one or more C₁₋₁₈ alcohols to form an intermediate product; (b) esterifying the intermediate product with a mixture of one or more C₁₋₄ alkyl polyalkylene glycols and one or more C₆₋₂₂ alkyl and/or alkenyl polyalkylene glycols to form an ester; and (c) neutralizing the ester with a base is provided. Anionic polymers prepared according to the process, and water-containing cement preparations or concrete incorporating the anionic polymers are also provided.

### FIELD OF THE INVENTION

This invention relates generally to polymers and, more particularly, to new anionic polymers based on acrylic acid compounds, to a process for their production and to their used as auxiliaries in the processing of cement and concrete.

### PRIOR ART

The preparation of water-containing cement preparations or concrete involves the problem of keeping the viscosity of the mix during production, transportation and use so low that problem-free processing is possible without the mixture become so thinly liquid that it runs from the mold. This equilibrium can be adjusted through the water content, although this generally requires such a large quantity that the cure time is greatly increased. For this reason, viscosity adjusters are added to the preparations, keeping their viscosity in the necessary range, even without the addition of relatively large quantities of water, and at the same time extending the open time to setting to such an extent that curing does not occur during transportation.

Various polymers and their use as cement or concrete plasticizers are known from the prior art. EP 1090901 A1 (Takemoto) relates to a process for the production of polyether esters with average molecular weights of 5,000 to 40,000, in which methoxy polyalkylene glycol ethers are first reacted with methacrylic acid and the monomers obtained are polymerized in aqueous solution. Polymers obtained by esterification of uncrosslinked polycarboxylic acids with polyethers are known from U.S. Pat. No. 5,614,017 and U.S. Pat. No. 5,670,578 (Arco). The reaction takes place in two steps, the mixture being heated first to 120° C. to remove water and then to 170° C. to carry out the actual esterification. According to U.S. Pat. No. 6,034,208 (Arco), hydroxy (meth)acrylates are reacted with alkylene oxides and the adducts obtained are then polymerized with acrylic acid. U.S. Pat. No. 5,919,300 (Sika) relates to copolymers which are obtained by the copolymerization of (a) N-vinylamides or lactams, (b) esters of methacrylic acid with polyethylene glycols and (c) methacrylsulfonic acid. U.S. Pat. No. 5,665,158 (Grace) describes polymers obtained by reaction of poly(meth)acrylic acid with alkoxylated amines. The teachings of U.S. Pat. No. 6,139,623 and U.S. Pat. No. 6,172,147 (Grace) augment this process to the extent that defoamers (tributyl phosphate) or anionic surfactants (alkyl ether sulfate) are added in a concluding step. In addition, EP 1396506 A1 (Cognis) describes anionic polymers for the purpose mentioned which are obtained by esterification of crosslinked polyacrylic acids with end-capped alkene glycols and subsequent neutralization.

Although the known additives are more or less satisfactory in regard to their performance properties, they are all attended by the disadvantage that their use in the cement or concrete mixes leads to unwanted foaming which can only be avoided by adding additional auxiliaries, such as foam suppressors or defoamers for example, to the preparations. Since these auxiliaries can adversely affect the viscosity-regulating properties and, in addition, are not always easy to incorporate in the formulations, it is obvious that there is a great desire to overcome this problem in the cement-processing industry.

Accordingly, the problem addressed by the present invention was to provide new polymeric additives for the production of water-containing cement preparations or concrete, so-called “superplasticizers”, which would be free of the disadvantages mentioned at the beginning and, in particular, would be foam-free or low-foaming so that there would no longer be any need to use foam-suppressing or defoaming additives.

### DESCRIPTION OF THE INVENTION

The present invention relates to new anionic polymers obtainable by
(a) polymerizing olefinically unsaturated carboxylic acids or esters thereof with C₁₋₁₈ alcohols optionally together with comonomers of the following types:
   (a1) dipropylene glycol diacrylate (DPGDA),
   (a2) tripropylene glycol diacrylate (TPGDA),
   (a3) acrylamidomethyl propanesulfonic acid (AMPS) and/or
   (a4) acrylic acid ethyl ester (AE),
(b) esterifying the resulting intermediate products with a mixture of
   (b1) C₁₋₄ alkyl polyalkylene glycols and
   (b2) C₆₋₂₂ alkyl and/or alkenyl polyalkylene glycols and
(c) neutralizing the esters thus obtained with bases.

It has surprisingly been found that not only do the new anionic polymers provide water-containing cement preparations or concrete with at least the same rheological behavior as the comparable known products and, in addition, retard setting, they are also foam-free or so low-foaming that there is no need to use foam-suppressing or defoaming additives in the formulations.

The present invention also relates to a process for the production of the new anionic polymers which comprises the steps of
(a) polymerizing olefinically unsaturated carboxylic acids or esters thereof with C₁₋₁₈ alcohols optionally together with comonomers of the following types:
   (a1) dipropylene glycol diacrylate (DPGDA),
   (a2) tripropylene glycol diacrylate (TPGDA),
   (a3) acrylamidomethyl propanesulfonic acid (AMPS) and/or
   (a4) acrylic acid ethyl ester (AE),
(b) esterifying the resulting intermediate products with a mixture of
   (b1) C₁₋₄ alkyl polyalkylene glycols and
   (b2) C₆₋₂₂ alkyl and/or alkenyl polyalkylene glycols and
(c) neutralizing the esters thus obtained with bases.

### Polymerization

In the first step, the olefinically unsaturated carboxylic acids or esters thereof are polymerized together with the comonomers. Suitable unsaturated carboxylic acids are acrylic acid, methacrylic acid and mixtures thereof. Alternatively, esters thereof with alcohols, such as for example isopropyl alcohol, the isomeric butanols, caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol or preferably methanol or ethanol, may also be used. The ratio by weight of the olefinically unsaturated components and the comonomers—where they are used—may be from 90:10 to 99:1, although 1 to 6% by weight and more particularly 2 to 5% by weight of the comonomers, based on the olefinic component, are preferably used. The polymerization may be carried out in known manner, i.e. in the presence of radical initiators, such as persulfates or bisulfites. After the start of the reaction, there is a marked increase in temperature and suitable measures, for example cooling in an ice bath, should be taken to ensure that the temperature does not exceed a value of 110° C. The reaction may be carried out in organic solvents, such as glycol for example, although an aqueous medium is preferably used. In general, the polymers then have an average molecular weight of 1,000 to 5,000 dalton.

### Esterification and Neutralization

In the second stage of the process, the formation of esters of the crosslinked polyacrylic acid compounds with a mixture of short-chain and long-chain polyalkylene glycols takes place.

Substances suitable as component (b1) for this purpose correspond to formula (I):

R¹(OCHCHR²)ₙOH (I)

in which R¹ represents C₁₋₄ alkyl groups, R² is hydrogen or a methyl group and n is a number of 1 to 10. The compounds (I) are preferably methyl polyethylene glycols. It is also preferred to use alkyl polyalkylene glycols and especially alkyl polyethylene glycols of formula (I) which have an average molecular weight of 200 to 2,000 and more particularly 500 to 1,000 dalton. Component (b1) provides the molecule above all with viscosity-reducing properties. Component (b2), which is responsible for the new defoaming properties in the molecule, may be selected from substances corresponding to formula (II):

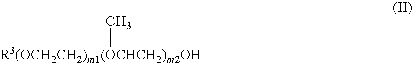

in which R³ represents alkyl and/or alkenyl groups containing 6 to 22, preferably 12 to 20 and more particularly 16 to 18 carbon atoms and m1 and m2 independently of one another stand for 0 or numbers of 1 to 20, with the proviso that m1 and m2 cannot both be 0. The compounds (II) are preferably addition products of on average 5 to 15 mol ethylene oxide and/or 5 to 15 mol propylene oxide onto technical coconut fatty alcohols. An addition product of 4 mol ethylene oxide and 11 mol propylene oxide onto technical cetearyl alcohol (Bublex 250, Cognis Iberia) is particularly preferred. Components (b1) and (b2) may be used in a ratio by weight of 90:10 to 10:90 and preferably in a ratio by weight of 80:20 to 50:50.

For the production of the esters, it is recommended to use the polyacrylic acid compounds and the sum of the polyalkylene glycols in a molar ratio of 2:1 to 5:1 and preferably in a molar ratio of 3:1 to 4:1. The reaction temperature may be in the range from 100 to 200° C. and is preferably in the range from ca. 120 to 180° C. In addition, it is recommended to apply reduced pressure and to remove the water of condensation continuously from the equilibrium. After the esterification, the polymers are adjusted to a pH of 6 to 8 with aqueous alkali metal hydroxides such as, for example, sodium or potassium hydroxide. Clear to milky white solutions with a solids content of 35 to 55% by weight are obtained in this way.

### Commercial Applications

The present invention also relates to the use of the new anionic polymers as viscosity-regulating or setting-retarding additives for water-containing cement preparations or concrete in which they may be present in quantities of 0.01 to 1 and preferably 0.1 to 0.5% by weight, based on the solids content of the preparations.

### EXAMPLES

### Example H1

(A) Production of the crosslinked polyacrylic acid. 25.2 g acrylic acid, 1.6 g dipropylene glycol diacrylate (DPGDA) and 41.2 g water were introduced into a polymerization reactor and cooled to 10° C. 1 g ammonium persulfate in 1.6 g water and 5.2 g sodium metabisulfite in 13.1 g water were then added with intensive stirring. The reaction temperature rose to 105° C. in 30 minutes. When a gradual reduction in temperature indicated that the reaction was over, water was added so that a milky white dispersion with a solids content of 52% by weight and an acid value of 265 was obtained. (B) Production of the polyacrylic acid ester. 300 g (1.42 mol) of the crosslinked polyacrylic acid produced as described in (A) were introduced into a reactor together with 225 g (0.3 mol) methyl-capped polyethylene glycol (molecular weight 750), 50 g (0.1 mol) coconut alcohol+7EO and 6 g p-toluenesulfonic acid and slowly heated to 120° C. The water formed during the reaction was continuously removed while a light vacuum was applied. When the water had been removed, the mixture was stirred for 3 h at 180° C. The resulting dark-colored liquid was neutralized with 40% by weight sodium hydroxide and diluted with water to a solids content of 46% by weight.

### Example H2

(A) Production of the crosslinked polyacrylic acid. 25.4 g acrylic acid, 0.8 g tripropylene glycol diacrylate (TPGDA) and 41.2 g water were introduced into a polymerization reactor and cooled to 10° C. 1 g ammonium persulfate in 1.6 g water and 5.2 g sodium metabisulfite in 13.1 g water were then added with intensive stirring. The reaction temperature rose to 105° C. in 30 minutes. When a gradual reduction in temperature indicated that the reaction was over, water was added so that a dispersion with a solids content of 37% by weight and an acid value of 203 was obtained. (B) Production of the polyacrylic acid ester. 433 g (1.57 mol) of the crosslinked polyacrylic acid produced as described in (A) were introduced into a reactor together with 150 g (0.2 mol) methyl-capped polyethylene glycol (molecular weight 750), 50 g (0.1 mol) coconut alcohol+7EO and 3 g p-toluenesulfonic acid and slowly heated to 120° C. The water formed during the reaction was continuously removed while a light vacuum was applied. When the water had been removed, the mixture was stirred for 3 h at 180° C. The resulting dark-colored liquid was neutralized with 40% by weight sodium hydroxide, diluted with water to a solids content of 46% by weight and had an acid value of 211.

### Example H3

(A) Production of the crosslinked polyacrylic acid. 300 g water were introduced into a polymerization reactor and heated to 100° C., followed by purging with nitrogen for 30 minutes. 272 g of a mixture of acrylic acid and methacrylic acid in a molar ratio of 1:1 and 48 g acrylamidomethyl propanesulfonic acid (AMPA) were then added. 9.8 g hydrogen peroxide, 28 g thioglycolic acid and 100 g water were then added with intensive stirring. The mixture was stirred for another 2 h at 100° C., cooled and then diluted with water so that a dispersion with a solids content of ca. 36% by weight and an acid value of 105 was obtained. (B) Production of the polyacrylic acid ester. 442 g (1.52 mol) of the crosslinked polyacrylic acid produced as described in (A) were introduced into a reactor together with 225 g (0.3 mol) methyl-capped polyethylene glycol (molecular weight 750), 50 g (0.1 mol) stearyl alcohol+7EO and 6 g p-toluenesulfonic acid and heated to 120° C. The water formed during the reaction was continuously removed while a light vacuum was applied. When the water had been removed, the mixture was stirred for 3 h at 180° C. The resulting dark-colored liquid was neutralized with 40% by weight sodium hydroxide and diluted with water to a solids content of 46% by weight.

### Example H4

(A) Production of the crosslinked polyacrylic acid. 350 g water were introduced into a polymerization reactor and heated to 85° C., followed by purging with nitrogen for 30 minutes. 358 g acrylic acid and 40 g acrylic acid ethyl ester were then added. 9.8 g hydrogen peroxide, 12.5 g propyl mercaptate and 120 g water were added over a period of 2 h with intensive stirring. The mixture was stirred for another hour at 85° C., cooled, adjusted to pH 7.5 with aqueous sodium hydroxide solution and then diluted with water so that a dispersion with a solids content of ca. 40% by weight was obtained. (B) Production of the polyacrylic acid ester. 480 g (1.55 mol) of the crosslinked polyacrylic acid/acrylic acid ester produced as described in (A) were introduced into a reactor together with 150 g (0.2 mol) methyl-capped polyethylene glycol (molecular weight 750), 96 g (0.2 mol) cetearyl alcohol+5EO and 6 g p-toluenesulfonic acid and heated to 120° C. The water formed during the reaction was continuously removed while a light vacuum was applied. When the water had been removed, the mixture was stirred for 3 h at 180° C. The resulting dark-colored liquid was neutralized with 40% by weight sodium hydroxide and diluted with water to a solids content of 46% by weight.

### Example H5

(A) Production of the crosslinked polyacrylic acid. In a polymerization reactor, 24 g acrylic acid, 0.8 g tripropylene glycol diacrylate and 41 g water were mixed at 10° C., followed by the addition of 1 g ammonium persulfate and 5 g sodium metabisulfite in 14 g water. The reactor was closed and heated for 1 h to a temperature of 105 to 110° C. The reaction mixture was then cooled, the reactor opened and the resulting crosslinked polyacrylic acid adjusted to a solids content of 26% by weight by addition of water. (B) Production of the polyacrylic acid ester. 300 g of the crosslinked polyacrylic acid produced as described in (A) were mixed with 265 g methyl-end-capped polyethylene glycol (molecular weight 500) and freed from traces of water in vacuo at ca. 60° C. 13 g of an addition product of 3 mol ethylene oxide and 6 mol propylene oxide onto cetearyl alcohol and 2 g p-toluenesulfonic acid as catalyst were then added and the mixture was heated for 10 h to 150° C. The resulting esterification product was adjusted to pH 7 by addition of sodium hydroxide solution and diluted with water to a solids content of 35% by weight.

### Comparison Example C1

(A) Production of the crosslinked polyacrylic acid. In a polymerization reactor, 24 g acrylic acid, 0.8 g tripropylene glycol diacrylate and 41 g water were mixed at 10° C., followed by the addition of 1 g ammonium persulfate and 5 g sodium metabisulfite in 14 g water. The reactor was closed and heated for 1 h to a temperature of 105 to 110° C. The reaction mixture was then cooled, the reactor opened and the resulting crosslinked polyacrylic acid adjusted to a solids content of 26% by weight by addition of water. (B) Production of the polyacrylic acid ester. 300 g of the crosslinked polyacrylic acid produced as described in (A) were mixed with 265 g methyl-end-capped polyethylene glycol (molecular weight 500) and freed from traces of water in vacuo at ca. 60° C. 2 g p-toluenesulfonic acid were then added and the mixture was heated for 10 h to 150° C. The resulting esterification product was adjusted to pH 7 by addition of sodium hydroxide solution and diluted with water to a solids content of 35% by weight.

### Performance Tests

300 g Portland cement, 850 standard sand (DIN-EN 196-1) and 130 g water were mixed and 1% by weight, based on Portland cement, of the polymers of Example H5 and Comparison Example C1 was added to the resulting mixture. The preparation was intensively mixed for 3 minutes in a mixer, after which the mean consistency was determined by the flow table test (ASTM C 124-UNI 8020/A-UNE 7102) along with the density of the preparations. The results are set out in Table 1.

TABLE 1
Consistency and density

| | Water Flow Table | Density [g/ec] |
|---|---|---|
| Control test | 0 | |
| 1% by weight Example H5 | 145 | 2.3 |
| 1% by weight Example C1 | 140 | 1.8 |

It can be seen that both products produce the same plasticizing and viscosity-reducing effect.

The polymers of Example H5 and Comparison Example C1 were diluted to a concentration of 2% by weight in water and the resulting solutions were introduced over a period of 1 minute into a circulation apparatus in which they had to free-fall a distance of 50 cm. The height of the foam above the solution was then determined. It was 0.5 ml in the case of the Example according to the invention and 120 ml in the case of the Comparison Example.

1. Anionic polymers obtainable by
(a) polymerizing olefinically unsaturated carboxylic acids or esters thereof with C₁₋₁₈ alcohols optionally together with comonomers of the following types:
(a1) dipropylene glycol diacrylate (DPGDA),
(a2) tripropylene glycol diacrylate (TPGDA),
(a3) acrylamidomethyl propanesulfonic acid (AMPS) and/or
(a4) acrylic acid ethyl ester (AE),
(b) esterifying the resulting intermediate products with a mixture of
(b1) C₁₋₄ alkyl polyalkylene glycols and
(b2) C₆₋₂₂ alkyl and/or alkenyl polyalkylene glycols and
(c) neutralizing the esters thus obtained with bases.

2. A process for the production of anionic polymers comprising the steps of
(a) polymerizing olefinically unsaturated carboxylic acids or esters thereof with C₁₋₁₈ alcohols optionally together with comonomers of the following types:
(a1) dipropylene glycol diacrylate (DPGDA),
(a2) tripropylene glycol diacrylate (TPGDA),
(a3) acrylamidomethyl propanesulfonic acid (AMPS) and/or
(a4) acrylic acid ethyl ester (AE),
(b) esterifying the resulting intermediate products with a mixture of
(b1) C₁₋₄ alkyl polyalkylene glycols and
(b2) C₆₋₂₂ alkyl and/or alkenyl polyalkylene glycols and
(c) neutralizing the esters thus obtained with bases.

3. A process as claimed in claim 2, characterized in that acrylic acid, methacrylic acid or mixtures thereof are used as the olefinically unsaturated carboxylic acid.

4. A process as claimed in claims 2 and/or 3, characterized in that esters of acrylic acid and/or methacrylic acid with methanol or ethanol are used as the olefinically unsaturated carboxylic acid esters.

5. A process as claimed in at least one of claims 2 to 4, characterized in that the olefinically unsaturated component and the comonomers are used in a ratio by weight of 90:10 to 99:1.

6. A process as claimed in at least one of claims 2 to 5, characterized in that alkyl polyalkylene glycols corresponding to formula (I):
R¹(OCHCHR²)ₙOH (I)
in which R¹ represents C₁₋₄ alkyl groups, R² is hydrogen or a methyl group and n is a number of 1 to 10, are used as component (b1).

7. A process as claimed in at least one of claims 2 to 6, characterized in that methyl polyethylene glycols are used.

8. A process as claimed in at least one of claims 2 to 7, characterized in that alkyl polyalkylene glycols of formula (I) having an average molecular weight of 200 to 2,000 dalton are used.

9. A process as claimed in at least one of claims 2 to 8, characterized in that alkyl and/or alkenyl polyalkylene glycols corresponding to formula (II): 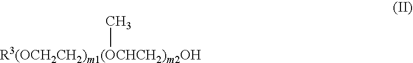
in which R³ represents alkyl and/or alkenyl groups containing 6 to 22, preferably 12 to 20 and more particularly 16 to 18 carbon atoms and m1 and m2 independently of one another stand for 0 or numbers of 1 to 20, with the proviso that m1 and m2 cannot both be 0, are used as component (b2).

10. A process as claimed in at least one of claims 2 to 9, characterized in that components (b1) and (b2) are used in a ratio by weight of 90:10 to 10:90.

11. A process as claimed in at least one of claims 2 to 10, characterized in that the polymers are adjusted to a pH of 6 to 8 with aqueous alkali metal hydroxides.

12. A process as claimed in at least one of claims 2 to 11, characterized in that aqueous neutralized preparations of the polymers which have a solids content of 40 to 50% by weight are produced.

13. The use of the anionic polymers claimed in claim 1 as viscosity-regulating additives for water-containing cement preparations or concrete.

14. The use of the anionic polymers claimed in claim 1 as setting-retarding additives for water-containing cement preparations or concrete.
